(19) United States
(12) Patent Application Publication
(10) Pub. No.: US 2024/0131996 A1
(43) Pub. Date: Apr. 25, 2024

(54) CLAMP ASSEMBLY AND KIT THEREFOR

(71) Applicant: SOUCY INTERNATIONAL INC., Drummondville (CA)

(72) Inventors: Jean-Michel LECLERC, Drummondville (CA); Hakim NAJEM, Drummondville (CA); Alexandre POUDRIER, Drummondville (CA); Simon BOUCHARD, Saint-Germain-De-Grantham (CA)

(21) Appl. No.: 18/492,988

(22) Filed: Oct. 23, 2023

Related U.S. Application Data
(60) Provisional application No. 63/418,842, filed on Oct. 24, 2022.

(51) Int. Cl. B60R 11/00

(52) U.S. Cl. CPC B60R 11/00; B60R 2011/0071; B60R 2011/0078

(57) ABSTRACT

A clamping assembly and a kit therefor are provided. The clamping assembly has a clamping component configured for selective attachment to a member of a vehicle, and a separate toolless fastener configured to selectively fasten an accessory to the clamping component. The clamping component and the accessory are configured to cooperate with the separate toolless fastener such that: when the separate toolless fastener engages the clamping component and the accessory, and is actuated to a locked position from an unlocked position, the separate toolless fastener selectively fastens the accessory to the clamping component

### CROSS-REFERENCE TO RELATED APPLICATION

The present application claims priority to U.S. Provisional Patent Application No. 63/418,842, filed Oct. 24, 2022 entitled “Clamp Assembly and Kit Therefor”, which is incorporated by reference herein in its entirety.

### TECHNICAL FIELD

The present technology relates to clamp assemblies and kits therefor.

### BACKGROUND

All-terrain vehicles (“ATV” or “ATVs”), utility-terrain vehicle (“UTV” or “UTVs”), side-by-side vehicles (“SSV” or “SSVs”), snowmobiles, and other vehicles, often equipped with accessories in order to modify the appearance and/or the performance of the vehicle.

Such vehicles are often used to perform different kinds of works and/or used in different environments. It is thus generally desirable to be able to easily install and remove accessories to such vehicles. However, most accessories often have to be installed using special tools.

There is thus a need for an attachment system which allows the installation and removal of an accessory to a vehicle.

### SUMMARY

It is an object of the present technology to ameliorate at least some of the inconveniences present in the prior art.

In some embodiments of the present technology, there is provided a clamp assembly comprising a clamping component and a separate toolless fastener. It is contemplated that the separate toolless fastener is configured to be manually operable, and without requiring specialized tools, to provide a “quick-action” characteristic to the clamp assembly. Developers of the present technology have realized that quick-action toolless fastener aid the operator when attaching, and detaching, an accessory to the vehicle.

In other embodiments of the present technology, the separate toolless fastener may be operable by the operator with only one hand. As such, the separate toolless fastener may be embodied as a single-handed operable fastener allowing freeing the other hand of the operator for handling the clamping component with more ease during assembly. Developers of the present technology have realized that providing a clamp assembly comprising a clamping component and a separate single-handed operable fastener allows the user to hold the clamping component in one hand and operate the separate single-handed operable fastener with the other hand, which is more convenient than employing a two-handed operable fastener.

The clamp assembly is used to selectively attach an accessory to a vehicle. For example, the accessory may be a windshield, a roof top, a mirror, a gas tank, a storage bin, a fire extinguisher, and the like. The clamp assembly may be used to selectively attach the accessory to a Roll-Over Protection Structure (ROPS) of the vehicle, to a rack of the vehicle, to a bumper of the vehicle, and the like. The cross-section of the member to which the clamp assembly may selective attach the accessory is not particularly limiting. For example, the member can have a circular cross-section, a square cross-section, and/or a more complex cross-section. It is contempered that in some embodiments, the clamping component of the clamp assembly may be shaped to match a given cross-section of the member.

In some embodiments, developers of the present technology have devised a clamp assembly that does not require the member of the vehicle to be adapted for selective fastening of the accessory to the member via the clamp assembly. As such, the accessory is not limited to be mounted onto a specific location along the member and does not affect a structural integrity of the member.

In other embodiments, developers of the present technology have devised a clamp assembly that does not necessitate permanent deformation of any of its component during selective attachment of the accessory to the member. This allows re-using the clamp assembly following a selective detachment of the accessory from the member.

In a first broad aspect of the present technology, there is provided a clamping assembly. The clamping assembly comprises a clamping component configured for selective attachment to a member of a vehicle. The clamping assembly comprises a separate toolless fastener configured to selectively fasten an accessory to the clamping component. The clamping component and the accessory are configured to cooperate with the separate toolless fastener such that: when the separate toolless fastener engages the clamping component and the accessory, and is actuated to a locked position from an unlocked position, the separate toolless fastener selectively fastens the accessory to the clamping component.

In some embodiments of the clamp assembly, the separate toolless fastener includes a housing, an actuator pivotably connected to the housing and configured to move between an open position and a close position, and a locking element pivotably connected to the housing and configured to move between the unlocked position and the locked position. The actuator and the locking element are configured to cooperate such that: when the actuator is moved from the open position to the close position, the locking element moves from the unlocked position to the locked position.

In some embodiments of the clamp assembly, the separate toolless fastener is a separate quick-action fastener.

In some embodiments of the clamp assembly, the separate toolless fastener is a separate single-handed operable fastener.

In some embodiments of the clamp assembly, the clamping component is an integral component of the accessory.

In some embodiments of the clamp assembly, the clamping component includes a clamping portion configured to selectively clamp onto the member, and an attachment portion extending from the clamping portion and configured to cooperate with the separate toolless fastener.

In some embodiments of the clamp assembly, the clamping portion is a resilient clamping portion configured for a snap-fit connection with the member.

In some embodiments of the clamp assembly, the attachment portion defines a lip for spacing the member from the accessory when the member is selectively fastened to the accessory.

In some embodiments of the clamp assembly, the attachment portion defines an aperture configured to receive the separate toolless fastener.

In some embodiments of the clamp assembly, the attachment portion further includes an interior chamber configured to receive the separate toolless fastener.

In some embodiments of the clamp assembly, the accessory defines an accessory aperture configured to selectively receive the attachment portion such that when the attachment portion is received by the accessory, the aperture is aligned with the accessory aperture.

In some embodiments of the clamp assembly, the attachment portion is a first attachment portion, the clamping portion further including a second attachment portion extending from the clamping portion and configured to cooperate with the separate toolless fastener.

In some embodiments of the clamp assembly, the clamping portion has a first jaw, the first attachment portion extending from the first jaw, and a second jaw pivotably connected to the first jaw, the second attachment portion extending from the second jaw. The first jaw and the second jaw are configured to cooperate for selective attachment to the member.

In some embodiments of the clamp assembly, the first jaw is a P-shaped jaw.

In some embodiments of the clamp assembly, the first jaw is a L-shaped jaw.

In some embodiments of the clamp assembly, the second attachment portion defines a second aperture configured to receive the separate toolless fastener.

In some embodiments of the clamp assembly, the second attachment portion further includes an interior chamber configured to receive the separate toolless fastener.

In some embodiments of the clamp assembly, the clamp assembly further comprises a cap configured for snap-fit connection to the locking element when the member is selectively fastened to the accessory.

In some embodiments of the clamp assembly, clamping component defines a first aperture and the accessory defines a second aperture, such that: when the locking element is received by the first aperture and the second aperture, and is in the locked position, the accessory is selectively fastened to the clamping component in a stacked configuration between the housing and the locking element.

In some embodiments of the clamp assembly, when the member is selectively fastened to the accessory, the actuator and the housing are located in an interior space of the vehicle, and the locking element is located outside the interior space of the vehicle.

In some embodiments of the clamp assembly, when the member is selectively fastened to the accessory, the actuator and the housing are located outside an inner space of the vehicle, and the locking elements is located in the inner space of the vehicle.

In some embodiments of the clamp assembly, the attachment portion is received by the accessory in a snap-fit configuration.

In some embodiments of the clamp assembly, the attachment is received by the accessory in a male-female configuration.

In some embodiments of the clamp assembly, the first jaw and the second jaw are configured to engage each other for selective attachment to the member.

In some embodiments of the clamp assembly, the first jaw and the second jaw are configured to cooperate in a male-female configuration for selective attachment to the member.

In some embodiments of the clamp assembly, the first jaw and the second jaw are configured to cooperate in a snap-fit configuration for selective attachment to the member.

In a second broad aspect of the present technology, there is provided a kit for a clamp assembly. The kit comprises a clamping component configured for selective attachment to a member of a vehicle. The kit comprises a separate toolless fastener configured to selectively fasten an accessory to the clamping component. The clamping component and the accessory are configured to cooperate with the separate toolless fastener such that: when the separate toolless fastener engages the clamping component and the accessory, and is actuated to a locked position from an unlocked position, the separate toolless fastener selectively fastens the accessory to the clamping component.

In some embodiments of the kit, the kit further comprises a second clamping component for selective attachment to the member of the vehicle.

In some embodiments of the kit, the kit further comprises the accessory.

In some embodiments of the kit, the clamping component is an integral component of the accessory.

In some embodiments of the kit, the kit further comprises a cap configured for a snap-fit connection with the separate toolless fastener when the separate toolless fastener selectively fastens the accessory to the clamping component

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1A shows a top front right perspective view of a clamp assembly and an accessory with a clamping component of the clamp assembly being shown in transparency, in accordance with a first embodiment of the present technology.

FIG. 1B shows a cross-sectional view of the clamp assembly and the accessory of FIG. 1, taken through the line 1B-1B.

FIG. 2A shows a front elevation view of the clamp assembly and the accessory of FIG. 1.

FIG. 2B shows a cross-sectional view of the clamp assembly and the accessory of FIG. 1, taken through the line 2B-2B.

FIG. 3A shows a right side elevation view of the clamp assembly and the accessory of FIG. 1 with the clamping component being shown in transparency.

FIG. 3B shows a left side elevation view of the clamp assembly and the accessory of FIG. 1 selectively attached to a member of a vehicle with the clamping component being shown in transparency.

FIG. 4A shows a top front right perspective view of a separate toolless fastener of the clamp assembly of FIG. 1 in a locked position.

FIG. 4B shows a top front right perspective view of the separate toolless fastener of FIG. 4A with a housing and a resilient rim being omitted.

FIG. 5A shows a bottom front left perspective view of a clamp assembly and an accessory in a first configuration, in accordance with a second embodiment of the present technology with a clamping component of the clamping assembly being shown in transparency.

FIG. 5B shows a bottom front left perspective view of the clamp assembly and the accessory of FIG. 5A in a second configuration, with the clamping component being shown in transparency.

FIG. 6A shows a bottom front left perspective view of a clamp assembly and an accessory in a first configuration, in accordance with a third embodiment of the present technology.

FIG. 6B shows a bottom front left perspective view of the clamp assembly and the accessory of FIG. 6A in a second configuration.

FIG. 7A shows a bottom front left perspective view of a clamp assembly and an accessory in a first configuration, in accordance with a fourth embodiment of the present technology, with a clamping component of the clamping assembly being shown in transparency.

FIG. 7B shows a bottom front left perspective view of the clamp assembly and the accessory of FIG. 7A in a second configuration, with the clamping component being shown in transparency.

FIG. 8A shows a bottom front left perspective view of a clamp assembly and an accessory in a first configuration, in accordance with a fifth embodiment of the present technology, with a clamping component of the clamping assembly being shown in transparency.

FIG. 8B shows a bottom front left perspective view of the clamp assembly and the accessory of FIG. 8A in a second configuration, with the clamping component being shown in transparency.

FIG. 9 shows a bottom front left perspective view of a clamp assembly and an accessory in a first configuration, in accordance with a sixth embodiment of the present technology, with a clamping component of the clamping assembly being shown in transparency.

FIG. 10 shows a top back right perspective view of a clamp assembly and an accessory in a first configuration, in accordance with a seventh embodiment of the present technology.

FIG. 11A shows a first known example of a toolless fastener.

FIG. 11B shows a second known example of a toolless fastener.

FIG. 11C shows a third known example of a toolless fastener.

FIG. 12 shows a left side elevation view of the clamp assembly of FIG. 1 with a snap-fitted cap.

### DESCRIPTION OF EMBODIMENTS

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

In the context of the following description, “outwardly” or “outward” means away from a longitudinal center plane of the mounting clamp, and “inwardly” or “inward” means toward the longitudinal center plane. In addition, in the context of the following description, “longitudinally” means in a direction parallel to the longitudinal center plane of the mounting clamp in a plane parallel to flat level ground, “laterally” means in a direction perpendicular to the longitudinal center plane along a width of the mounting clamp, and “generally vertically” means in a direction contained in the longitudinal center plane along a height direction of the mounting clamp. Note that in the Figures, a “+” symbol is used to indicate an axis of rotation. In the context of the present technology, the term “axis” may be used to indicate an axis of rotation. Also, the term “pivot” includes all the necessary structure (bearing structures, pins, axles and other components) to permit a structure to pivot/rotate about an axis, as the case may be.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

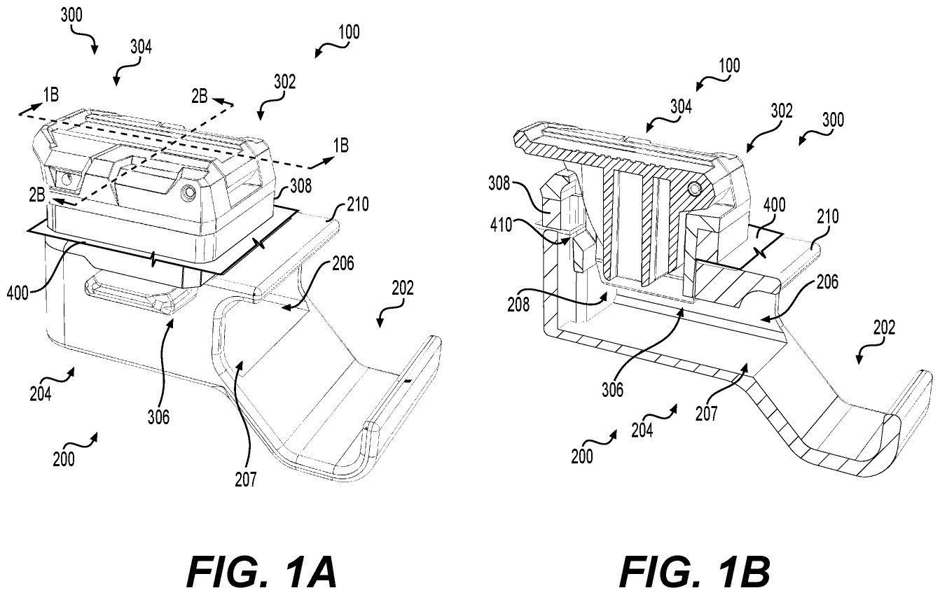

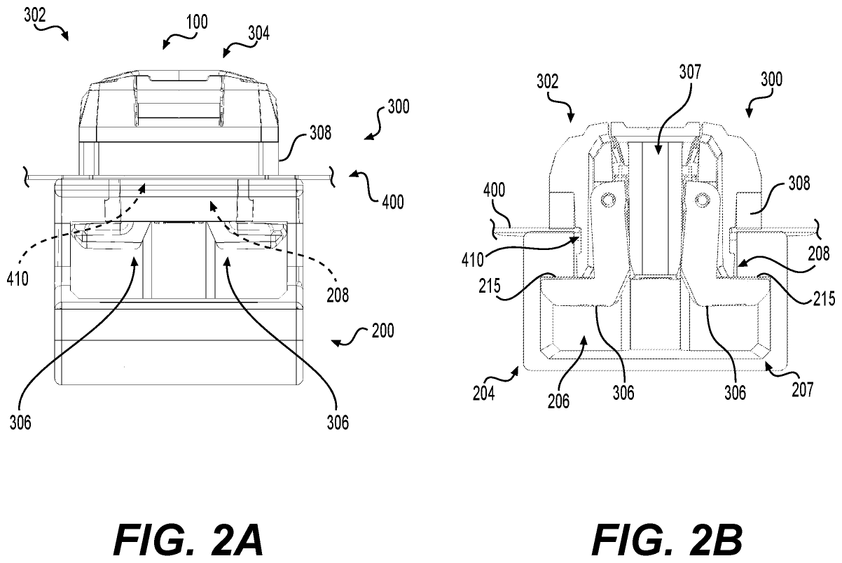

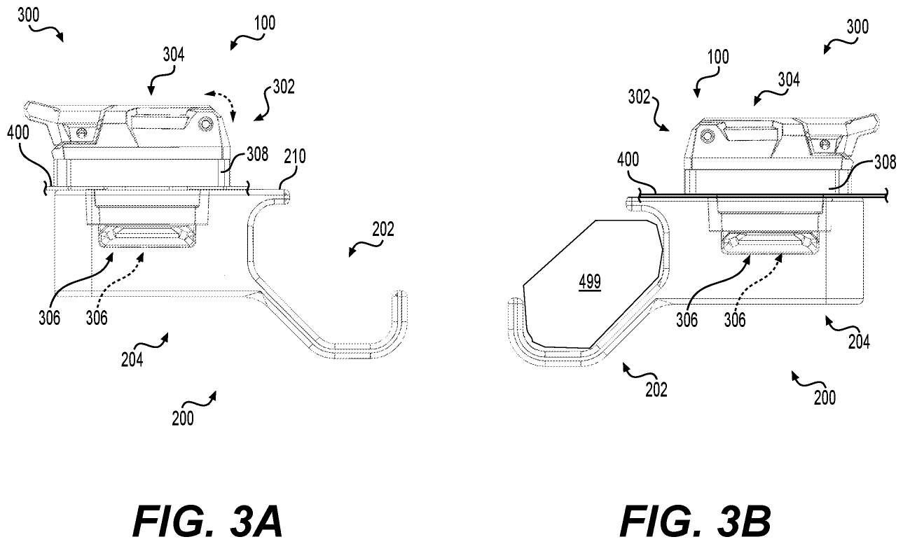

With reference to FIGS. 1A to 3B, there is depicted a non-limiting embodiment of a clamp assembly 100. Broadly speaking, the clamp assembly 100 is configured to selectively attach an accessory 400 to a member 499 (shown in FIG. 3B) of a vehicle (not depicted). As it will be described in greater detail herein further below, in this embodiment, the accessory 400 has an aperture 410 for receiving at least a portion of the clamp assembly 100.

In this embodiment, the clamp assembly 100 comprises (i) a clamping component 200 configured for selective attachment to the member 499 and (ii) a toolless fastener 300 configured for selective fastening of the accessory 400 to the clamping component 200.

The toolless fastener 300 can be said to be a “separate” component of the clamp assembly 100, since the clamping component 200 is not integrated with the toolless fastener 300 as a single component. Developers of the present technology have realized that providing a given clamp assembly with a toolless fastener that is separate from the clamping component may allow the operator to employ the toolless fastener without using the clamping component. For example, the separate toolless fastener may be used by the operator for selectively fastening the accessory directly to a member of the vehicle and/or in combination with a variety of other clamping components that may be provided as part of a same kit.

In this embodiment, the accessory 400 is a windshield. However, in other embodiments, a given accessory may be a roof top, a mirror, a fire extinguisher, a toolbox, a storage container, a gas tank, a rack, a vehicle panel, a cab light, a luggage bag, a gun case, a camera, a chainsaw, a shovel, and/or any other accessory to be mounted on the vehicle.

It should be noted that some accessories may be more fragile than others. For example, a windshield can be prone to cracking (or increasing the size of an existing crack) when absorbing load/vibrations from the vehicle during operation. Developers of the present technology have realized that providing a clamp assembly that can reduce load transmission from the member 499 to the accessory 400 (i.e., from the part on which the accessory 400 is mounted to the accessory 400) during operation of the vehicle may reduce wear of the accessory 400 and/or increase a lifespan thereof.

In this embodiment, the member 499 is a portion of a Roll-Over Protection Structure (ROPS) of the vehicle. It is contemplated that in some embodiments, a given member may be a structural component of the vehicle. In one embodiment, the given member may be a structural component of a powersport vehicle (e.g., a snowmobile, a quad, a ATV, a Side-by-Side, a UTV, a cross-country motorcycle, and the like) configured to support one or more accessories that the operator wishes to selectively attach to that vehicle. It is understood that a given member may be a structural component of other types of vehicles, such as agricultural, industrial, military, and exploratory vehicles for instances.

The specific location of the member 499 on the vehicle is not particularly limiting. For example, the member may be provided near a front portion of the vehicle (e.g., handlebars), near a middle portion of the vehicle (e.g., frame), and near a rear portion of the vehicle (e.g., a rear cabin). In some embodiments, the member of the vehicle may be a rack, a bumper, and the like. As it will become apparent from the description herein further below, the member of the vehicle may have a circular cross-section, or not, depending on a specific implementation of the present technology. Developers of the present technology have devised clamp assemblies and kits for use with a variety of different members of a vehicle.

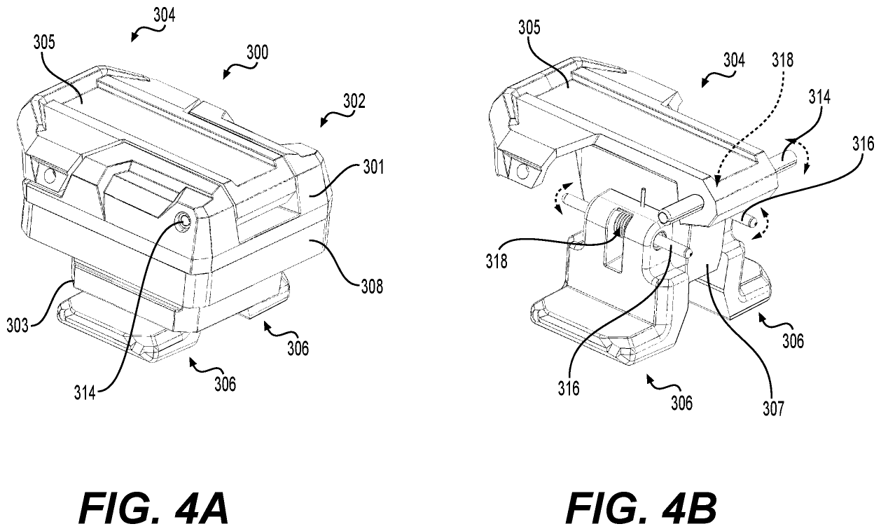

With reference to FIGS. 4A and 4B, the toolless fastener 300 comprises a housing 302, an actuator 304, and a pair of locking elements 306. The housing 302 comprises a rim portion 301 and a receivable portion 303. As it will be discussed in greater details herein below, the receivable portion 303 may be received by the accessory 400 via the aperture 410 and by one or more other components of the clamp assembly 100 during assembly. The toolless fastener 300 also comprises a resilient rim portion 308 extending from the rim portion 301 of the housing 302.

The actuator 304 is pivotally mounted to the housing 302 such that the actuator 304 can be pivoted between a close position (see FIG. 4A) and an open position. In this embodiment, the actuator 304 has a handle portion 305 and a cam portion 307 extending from the handle portion 305. The actuator 304 is configured to pivot about an axle 318 between the close position and the open position. The actuator 304 is configured to actuate the two locking elements 306 (via the cam portion 307) such that they lockingly engage with the clamping component 200.

The locking elements 306 are also pivotally mounted to the housing 302 such that they can be pivoted between an unlocked position and a locked position (see FIG. 4B). The locking elements 306 are configured to pivot about respective axles 316 between the unlocked position and the locked position. It is contemplated that although the toolless fastener 300 comprises two locking elements this might not be the case in each and every embodiment of the present technology. For example, a given toolless fastener may comprise one or more than two locking elements.

In this embodiment, when the locking elements 306 are in the unlocked position, they are generally fully retracted within the housing 302. In this embodiment, the locking elements 306 are L-shaped and each comprise a first extremity pivotally mounted to the housing 302 and a second extremity that is free. It is contemplated that pivotal connections between the first extremities of the locking elements 306 and the housing 302 may further comprise recall mechanisms to bias the locking elements 306 toward their unlocked position. In this embodiment, the recall mechanisms are embodied as torsion springs 318.

During operation, the actuator 304 is configured to interact with (via the cam portion 307) and actuate the locking elements 306 such that: (i) when the actuator 304 is in the open position, the locking elements 306 are in their unlocked position, and (ii) when the actuator 304 is in the close position, the locking elements 306 are in their locked position.

Broadly speaking, the toolless fastener 300 is manually operable, and without requiring specialized tools, to provide a “quick-action” characteristic to the clamp assembly 100 for aiding the operator when attaching and detaching the accessory 400 to the member 499.

In this embodiment, the toolless fastener 300 is a pivotal toolless fastener 300 due to the pivotal connection of the actuator 304. Developers of the present technology have realized that providing a pivotal actuator 304, as opposed to a linear actuator for example (i.e., linear actuation movement), reduces the risk of inadvertent unlocking of the toolless fastener 300 during operation of the vehicle.

In this embodiment, the operator can operate the toolless fastener 300 with a single hand. Developers of the present technology have realized that providing a single-handed operable fastener allows freeing the other hand of the operator for handling the clamping component 200 with more ease during assembly.

It will also be noted that other types of separate toolless fasteners 300 may be used with the clamping assembly of the present technology.

In at least some embodiments of the present technology, the separate toolless fastener may be implemented in a similar manner to a locking mechanism disclosed in a U.S. Pat. No. 9,643,675, entitled “Attachment system and method of using the same”, granted on May 9, 2017, the contents of which is incorporated herein by reference in its entirety.

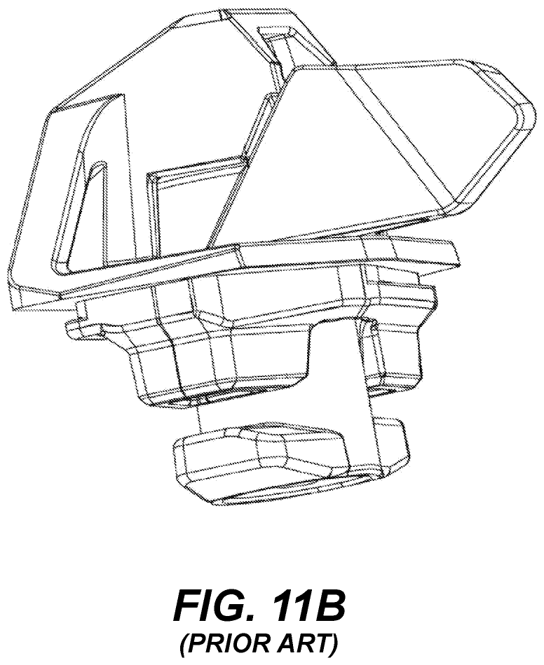

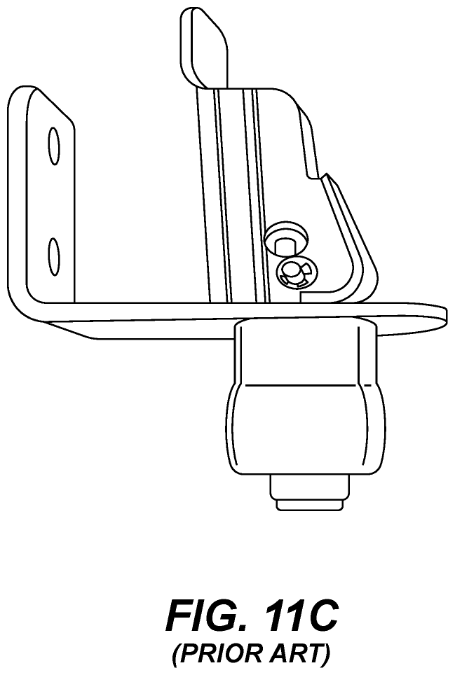

In other embodiments of the present technology, the separate toolless fastener may be implemented in a similar manner to a retaining device disclosed in a U.S. Pat. No. 9,919,657, entitled “Retaining device for vehicle racks”, granted on Mar. 20, 2018, the contents of which is incorporated herein by reference in its entirety. An example of the retaining device is illustrated in FIG. 11A.

In further embodiments of the present technology, the separate toolless fastener may be implemented in a similar manner to an anchor fixture disclosed in a U.S. Pat. No. 9,751,592, entitled “Systems and methods for attachment of vehicle accessories”, granted on Sep. 5, 2017, the contents of which is incorporated herein by reference in its entirety. An example of the anchor fixture is illustrated in FIG. 11B.

In additional embodiments of the present technology, the separate toolless fastener may be implemented in a similar manner to an accessory retainer disclosed in a U.S. Pat. No. 7,055,454, entitled “Vehicle expansion retainer”, granted on Jun. 6, 2006, the contents of which is incorporated herein by reference in its entirety. An example of the accessory retainer is illustrated in FIG. 11C.

Returning to the description of FIGS. 1A to 3B, the clamping component 200 comprises a resilient clip portion 202 and an attachment portion 204 extending from the resilient clip portion 202. As best seen in FIG. 3B, the resilient clip portion 202 is configured for a “snap-fit” connection with the member 499. Broadly, the resilient clip portion 202 is configured to resiliently deform and interlock (i.e., snap-fit) with the member 499. The shape of the resilient clip portion 202 may depend on inter alia a cross-sectional shape of the member 499.

In this embodiment, the clamping component 200 defines a spacing lip 210 extending away from the attachment portion 204 and between the member 499 and the accessory 400. Developers of the present technology have realized that providing a lip for spacing apart the member 499 and the accessory 400 (when the accessory 400 is selectively fastened to the member 499) may reduce the risk of contact between the accessory 400 and the member 499 during operation of the vehicle. It should be noted that reducing the risk of contact between the accessory 400 and the member 499 can reduce transmission of load from the member 499 to the accessory 400 (e.g., vibrations).

In this embodiment, the attachment portion 204 defines an interior chamber 206. The attachment portion 204 also defines a top aperture 208 and a front aperture 207 of the interior chamber 206. The interior chamber 206 provides room for at least a portion of the toolless fastener 300 when the portion is received in the top aperture 208. Developers of the present technology have realized that providing a given attachment portion with a chamber may shield at least a portion of the toolless fastener 300 from the environment, which reduces the risk of wear and/or inadvertent unlocking thereof. It should be noted that the chamber 206 may be omitted.

During assembly, the pair of locking elements 306 and the receivable portion 303 are received in the aperture 410 of the accessory 400. Also, the pair of locking elements 306 and the receivable portion 303 are received in the top aperture 208 of the attachment portion 204. Once the pair of locking elements 206 and the receivable portion 303 are received in both the aperture 410 and the top aperture 208, the operator actuates the actuator 304 from the open position to the close position, which moves the pair of locking elements 306 (via the cam portion 307) from the unlocked position to the locked position.

When the pair of locking elements 306 is in the locked position, the pair of locking elements 306 contact a surface 215 of the attachment portion 204 and bias the attachment portion 204 towards the accessory 400. It can be said that the accessory 400 is hence selectively fastened to the clamping component 200 in a “stacked” configuration between the resilient rim portion 308 of the toolless fastener 300 and the attachment portion 204 of the clamping component 200.

During assembly, the resilient clip portion 202 is snap-fitted onto the member 499. The operator 202 may snap-fit the resilient clip portion 202 onto the member 499 before, or after, selectively fastening the accessory 400 to the attachment portion 204 using the toolless fastener 300.

When the accessory 400 is selectively fastened to the member 499, the operator can actuate the actuator from the close position to the open position, which disengages the cam portion 307 from the locking elements 306. The torsion springs 318 bias the locking elements 306 from their locked position to their unlocked position. The operator can then remove the toolless fastener 300 from the apertures 410 and 208 thereby selectively detaching the accessory 400 from the clamping component 200.

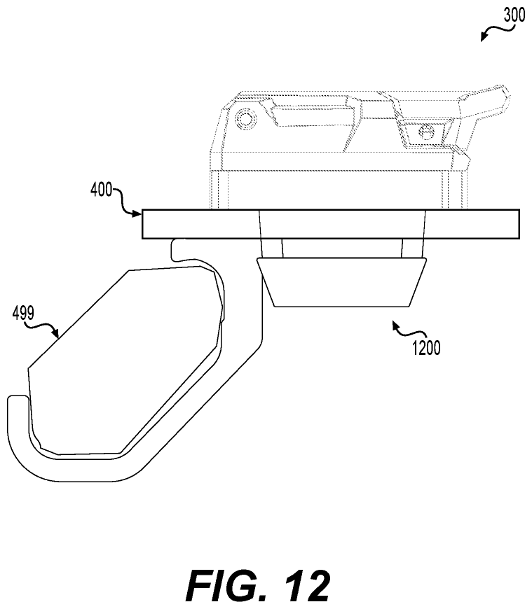

In some embodiments, when the member 499 is selectively fastened to the accessory 400, the actuator 304 and the housing 302 are located in an interior space of the vehicle, and the locking elements 306 are located outside the interior space of the vehicle. Developers of the present technology have realized that selectively fastening the member 499 to the accessory 400 such that the actuator and the housing are located inside the interior space and the locking elements 306 are located outside the interior space may reduce the risk of theft and/or may be more esthetically pleasing to the operator. In these embodiments, clamp assembly and/or a kit therefor may further comprise a snap-fit cap 1200 (see FIG. 12) for shielding the locking elements 306 from the environment. In other embodiments, when the member 499 is selectively fastened to the accessory 400, the actuator 304 and the housing 302 are located outside of an inner space of the vehicle, and the locking elements 306 are located in the inner space of the vehicle. Developers of the present technology have realized that selectively fastening the member 499 to the accessory 400 such that the actuator and the housing are located outside the interior space and the locking elements 306 are located inside the interior space may reduce wear of the locking elements that would otherwise be exposed to the environment and/or may be more esthetically pleasing to the operator.

It is contemplated that in at least some assembly configurations, the locking elements 306 are configured to engage the clamping component 200 when selectively fastening the accessory 400 to the member 499. Developers have realized that, in at least some cases, the accessory 400 is comparatively less stressed by having the locking elements 306 engaged the clamping component 200 for selective fastening, as opposed to having the locking elements 306 engaging the accessory 400 for selective fastening. It should also be noted that when a given clamp assembly selectively fastens the accessory 400 to the member 499 in a stacked configuration, stress applied onto the accessory 400 is mainly due to compression between portions of the given clamp assembly, as opposed to stress applied due to expansion of fastening elements inside the aperture of the accessory 400 and/or due to contact between the member 499 and the accessory 400, for example.

In at least some embodiments of the present technology, the clamping component 200 may be an integral component of the accessory 400. In other embodiments, attachment portion 204 and/or the accessory 400 may be adapted for receiving the other one of the attachment portion 204 and the accessory 400 during assembly. For example, the attachment portion 204 and the accessory 400 may be configured to engage each other in a “male-female” configuration so as to guide the attachment portion 204 relative to the accessory 400 during assembly and/or to align the aperture 410 with the aperture 208. In some embodiments, the attachment portion 204 and the accessory 400 may be configured to engage each other in a “snap-fit” configuration. Developers of the present technology have realized that having the attachment portion 204 and the accessory 400 engage each other may be desirable as it allows to free a hand of the operator during assembly and/or disassembly and which would otherwise be used to hold the attachment portion 204 in a correct position relative to the accessory 400. Optionally, having the attachment portion 204 and the accessory 400 engage each other may be desirable as it allows leaving the clamping component 200 engaged with the accessory 400 for a future reattachment to the member 499.

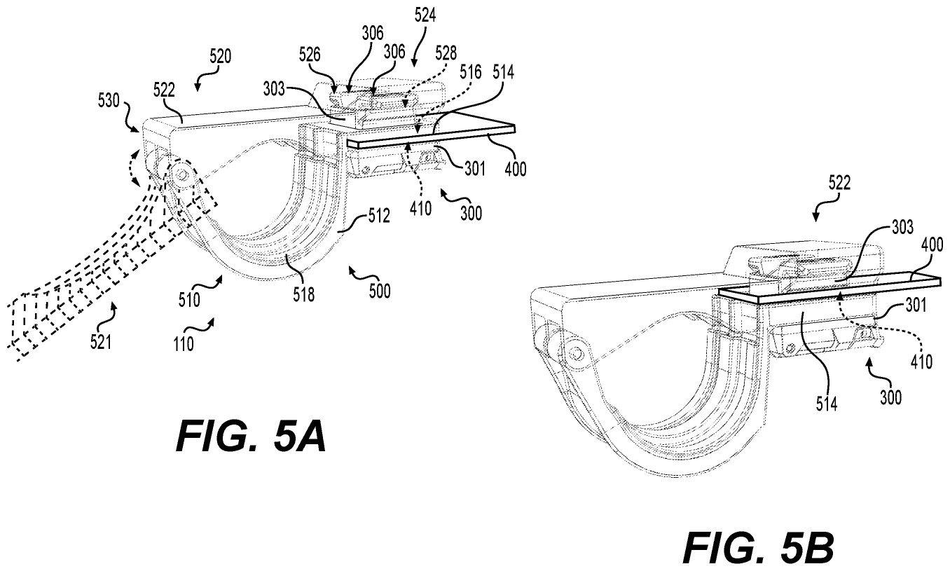

With reference to FIGS. 5A and 5B, there is depicted a clamp assembly 110 in accordance with an other embodiment of the present technology. The clamp assembly 110 comprises the toolless fastener 300 (the resilient rim portion 308 has been omitted) and a clamping component 500.

The clamping component 500 comprises a first jaw structure 510, and a second jaw structure 520 pivotably connected to the first jaw structure 510 via a hinge 530. The first jaw structure 510 comprises a P-shaped jaw 512 and an attachment portion 514. The P-shaped jaw 512 includes a padding 518 on inner surface thereof and is shaped to receive a given member of the vehicle. The attachment portion 514 defines an aperture 516 for receiving at least a portion of the toolless fastener 300. The second jaw structure 520 comprises a linear jaw 522 and an attachment portion 524. An inner surface of the linear jaw 522 is shaped to receive the given member of the vehicle. The attachment portion 524 defines an interior chamber 526 and an aperture 528 for receiving at least a portion of the toolless fastener 300.

In some embodiments, at least one of the first and second jaw structures 510,520 and/or the accessory 400 may be adapted for receiving the other one of the at least one of the first and second jaw structures 510,520 and/or the accessory 400 during assembly. For example, the first jaw structure 510 and the accessory 400 may be configured to engage each other in a “male-female” configuration so as to guide and/or maintain a position of the first jaw structure 510 relative to the accessory 400 during assembly. In another example, the first jaw structure 510 and the accessory 400 may be configured to engage each other in a “snap-fit” configuration so as to guide and/or maintain a position of the first jaw structure 510 relative to the accessory 400 during assembly.

In some embodiments, at least one of the first and second jaw structures 510,520 may be adapted for receiving the other one of the at least one of the first and second jaw structures 510,520 during assembly. For example, the first jaw structure 510 and the second jaw structure 520 may be configured to engage each other in a “male-female” configuration so as to guide and/or maintain a position of the first jaw structure 510 relative to the second jaw structure 520 during assembly. In another example, the first jaw structure 510 and the second jaw structure 520 may be configured to engage each other in a “snap-fit” configuration so as to guide and/or maintain a position of the first jaw structure 510 relative to the second jaw structure 520 during assembly.

During assembly, a given member of the vehicle is received in the P-shaped jaw 512. The second jaw structure 520 is moved from an open position (see position 521) to a close position, such that the member is in contact with both the padding 518 and the inner surface of the linear jaw 522.

The pair of locking elements 306 and the receivable portion 303 are then received in the aperture 410 of the accessory 400. Also, the pair of locking elements 306 and the receivable portion 303 are received in the aperture 516 of the attachment portion 514. Also, the pair of locking elements 306 and the receivable portion 303 are received in the aperture 528 and are introduced into the interior chamber 526 of the attachment portion 524. The operator then actuates the actuator 304 from the open position to the closed position, which moves the pair of locking elements 306 from the unlocked position to the locked position.

In FIG. 5A, the accessory 400 is hence selectively fastened to the clamping component 500 in a first “stacked” configuration between (i) the rim portion 301 of the toolless fastener 300 on one side thereof, and (ii) the attachment portions 514 and 524 on the other side thereof.

However, the clamping component 110 may selectively attach the accessory 400 to the member 499 in a second stacked configuration as seen in FIG. 5B. During assembly in the second stacked configuration, the pair of locking elements 306 and the receivable portion 303 are received in the aperture 516 of the attachment portion 514. The pair of locking elements 306 and the receivable portion 303 are then received in the aperture 410 of the accessory 400. The given member of the vehicle is then received in the P-shaped jaw 512. The second jaw structure 520 is moved from the open position to the close position, such that the member is in contact with both the padding 518 and the inner surface of the curved jaw 522.

Once the second jaw structure 520 is moved to the close position, the pair of locking elements 306 and the receivable portion 303 are received in the aperture 528 and are introduced into the interior chamber 526 of the attachment portion 524. The operator then actuates the actuator 304 from the open position to the closed position, which moves the pair of locking elements 306 from the unlocked position to the locked position.

In FIG. 5B, the accessory 400 is hence selectively fastened to the clamping component 500 in the second stacked configuration between (i) the rim portion 301 of the toolless fastener 300 and the attachment portion 514 on one side thereof, and (ii) the attachment portion and 524 on the other side thereof.

It is contemplated that in some embodiments of the present technology, a given clamping component may include two jaw structures that are configured to pivot relative to one another about a hinge of the given clamping component. In some embodiments, the hinge may include an axle. In other embodiment, the hinge may be embodied as a fold line defining a bend axis in the given clamping component.

In at least some embodiments of the present technology, one of the first jaw structure 510 and the second jaw structure 520 may be an integral component of the accessory 400.

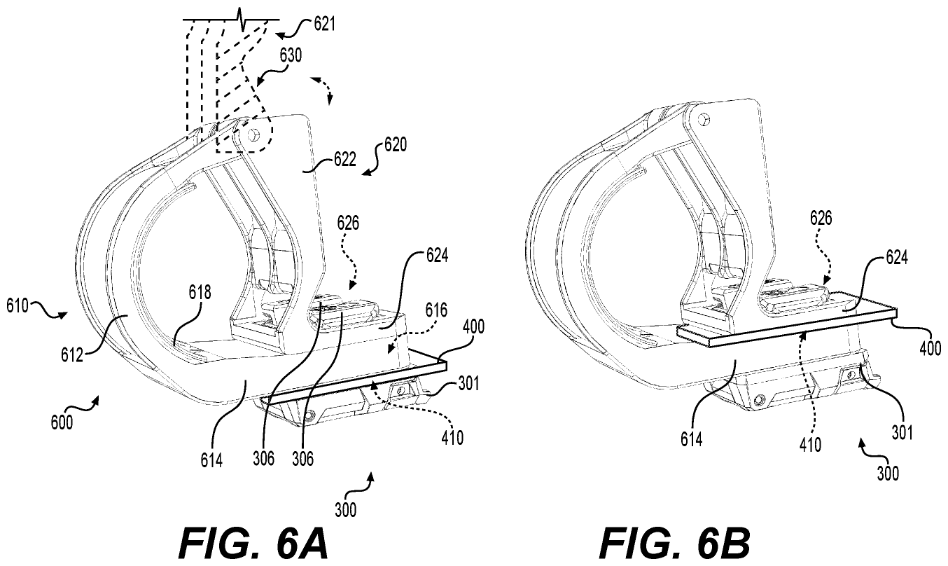

With reference to FIGS. 6A and 6B, there is depicted a clamp assembly 120 in accordance with an other embodiment of the present technology. The clamp assembly 120 comprises the toolless fastener 300 (the resilient rim portion 308 has been omitted) and a clamping component 600.

The clamping component 600 comprises a first jaw structure 610, and a second jaw structure 620 pivotably connected to the first jaw structure 610 via a hinge 630. The first jaw structure 610 comprises a P-shaped jaw 612 and an attachment portion 614. The P-shaped jaw 612 includes a padding 618 on inner surface thereof and is shaped to receive a given member of the vehicle. The attachment portion 614 defines an aperture 616 for receiving at least a portion of the toolless fastener 300. It should be noted that the attachment portion 614 extends in a different manner from the P-shaped jaw 612 if compared to the attachment portion 514 and the P-shaped jaw 512 of the clamping component 500 in FIGS. 5A and 5B. This allows a different orientation of the accessory 400 relative to the given member or relative to the vehicle itself.

The second jaw structure 620 comprises an L-shaped jaw 622 and an attachment portion 624. An inner surface of the L-shaped jaw 622 is shaped to receive the given member of the vehicle. The attachment portion 624 defines an aperture 626 for receiving at least a portion of the toolless fastener 300.

In some embodiments, at least one of the first and second jaw structures 610,620 and/or the accessory 400 may be adapted for receiving the other one of the at least one of the first and second jaw structures 610,620 and/or the accessory 400 during assembly. For example, the first jaw structure 610 and the accessory 400 may be configured to engage each other in a “male-female” configuration so as to guide and/or maintain a position of the first jaw structure 610 relative to the accessory 400 during assembly. In another example, the first jaw structure 610 and the accessory 400 may be configured to engage each other in a “snap-fit” configuration so as to guide and/or maintain a position of the first jaw structure 610 relative to the accessory 400 during assembly.

In some embodiments, at least one of the first and second jaw structures 610,620 may be adapted for receiving the other one of the at least one of the first and second jaw structures 610,620 during assembly. For example, the first jaw structure 610 and the second jaw structure 620 may be configured to engage each other in a “male-female” configuration so as to guide and/or maintain a position of the first jaw structure 610 relative to the second jaw structure 620 during assembly. In another example, the first jaw structure 610 and the second jaw structure 620 may be configured to engage each other in a “snap-fit” configuration so as to guide and/or maintain a position of the first jaw structure 610 relative to the second jaw structure 620 during assembly.

During assembly in a first stacked configuration seen in FIG. 6A, a given member of the vehicle is received in the P-shaped jaw 612. The second jaw structure 620 is moved from an open position (see position 621) to a close position, such that the member is in contact with both the padding 618 and the inner surface of the L-shaped jaw 622. The pair of locking elements 306 and the receivable portion 303 are then received in the aperture 410 of the accessory 400. Also, the pair of locking elements 306 and the receivable portion 303 are received in the aperture 616 of the attachment portion 614. Also, the pair of locking elements 306 and the receivable portion 303 are received in the aperture 626 of the attachment portion 624. The operator then actuates the actuator 304 from the open position to the closed position, which moves the pair of locking elements 306 from the unlocked position to the locked position. In FIG. 6A, the accessory 400 is hence selectively fastened to the clamping component 600 in a first “stacked” configuration between (i) the rim portion 301 of the toolless fastener 300 on one side thereof, and (ii) the attachment portions 614 and 624 on the other side thereof.

During assembly in the second stacked configuration seen in FIG. 6B, the pair of locking elements 306 and the receivable portion 303 are received in the aperture 616 of the attachment portion 614. The pair of locking elements 306 and the receivable portion 303 are then received in the aperture 410 of the accessory 400. The given member of the vehicle is then received in the P-shaped jaw 612. The second jaw structure 620 is moved from the open position to the close position, such that the member is in contact with both the padding 618 and the inner surface of the curved jaw 622. Once the second jaw structure 620 is moved to the close position, the pair of locking elements 306 and the receivable portion 303 are received in the aperture 626 of the attachment portion 624. The operator then actuates the actuator 304 from the open position to the closed position, which moves the pair of locking elements 306 from the unlocked position to the locked position. In FIG. 6B, the accessory 400 is hence selectively fastened to the clamping component 600 in the second stacked configuration between (i) the rim portion 301 of the toolless fastener 300 and the attachment portion 614 on one side thereof, and (ii) the attachment portion and 624 on the other side thereof.

In at least some embodiments of the present technology, one of the first jaw structure 610 and the second jaw structure 620 may be an integral component of the accessory 400.

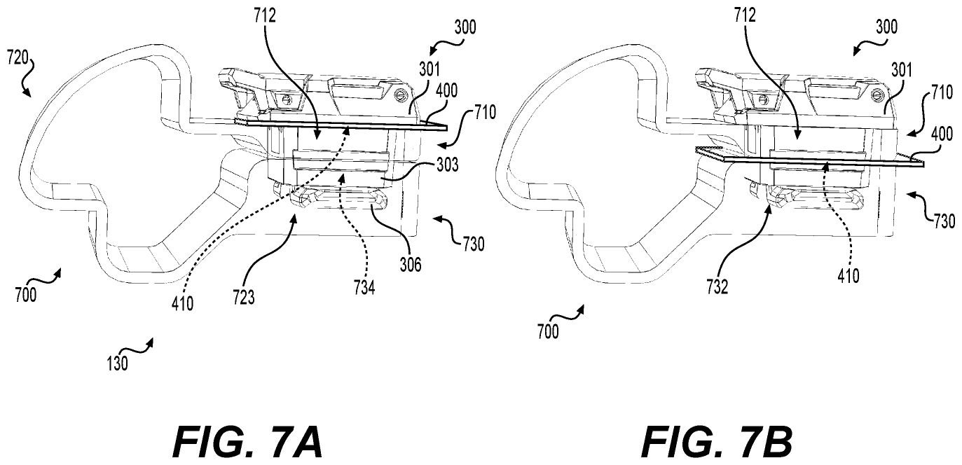

With reference to FIGS. 7A and 7B, there is depicted a clamp assembly 130 in accordance with an other embodiment of the present technology. The clamp assembly 130 comprises the toolless fastener 300 (the resilient rim portion 308 has been omitted) and a clamping component 700.

The clamping component 700 comprises a resilient clip portion 720 and an attachment portion 710 extending from the resilient clip portion 720 on the one side thereof, an attachment portion 710 extending from the resilient clip portion 720 on the other side thereof. The resilient clip portion 720 is shaped for a snap-fit connection onto a given member of the vehicle. In further embodiments, it is contemplated that a given clip portion may be flexible so as to wrap around the member 299. It is contemplated that a given clip portion may have a complementary shape to the cross-sectional shape of the member 499. The attachment portion 710 defines a channel 712 for receiving at least a portion of the toolless fastener 300. The attachment portion 730 defines an interior chamber 732 and an aperture 734 for receiving at least a portion of the toolless fastener 300.

In some embodiments of the present technology, it can be said that a given resilient clip portion of a clamping component may completely wrap around the member 299 when attached thereto. In these embodiments, it can also be said that when the given resilient clip portion is attached to the member 499, the given resilient clip portion forms a close-ended shape. In other embodiments, however, a given resilient clip portion may only partially wrap around the member 499 when attached thereto. In these embodiments, it can also be said that when the given resilient clip portion is attached to the member 499, the given resilient clip portion forms an open-ended shape.

It is contemplated that a given resilient clip portion may be made from a resilient material such as rubber and/or plastic. Developers of the present technology have realized that providing a resilient clip portion may in some cases reduce vibrations transmitted to the accessory.

In some embodiments, at least one of the first and second attachment portions 710,730 and/or the accessory 400 may be adapted for receiving the other one of the at least one of the first and second attachment portions 710,730 and/or the accessory 400 during assembly. For example, the first attachment portion 710 and the accessory 400 may be configured to engage each other in a “male-female” configuration so as to guide and/or maintain a position of the first attachment portion 710 relative to the accessory 400 during assembly. In another example, first attachment portion 710 and the accessory 400 may be configured to engage each other in a “snap-fit” configuration so as to guide and/or maintain a position of first attachment portion 710 relative to the accessory 400 during assembly.

In some embodiments, at least one of the first and second attachment portions 710,730 may be adapted for receiving the other one of the at least one of the first and second attachment portions 710,730 during assembly. For example, the first attachment portion 710 and the second attachment portion 730 may be configured to engage each other in a “male-female” configuration so as to guide and/or maintain a position of the first attachment portion 710 relative to the second attachment portion 730 during assembly. In another example, the first attachment portion 710 and the second attachment portion 730 may be configured to engage each other in a “snap-fit” configuration so as to guide and/or maintain a position of the first attachment portion 710 relative to the second attachment portion 730 during assembly.

During assembly in a first stacked configuration seen in FIG. 7A, the given member is inserted between the attachment portions 710 and 730 and the resilient clip portion 720 is snap-fitted onto the given member. The pair of locking elements 306 and the receivable portion 303 are received in the aperture 410 of the accessory 400. The pair of locking elements 306 and the receivable portion 303 are received in the channel 712 of the attachment portion 710. The pair of locking elements 306 and the receivable portion 303 are received in the aperture 734 and are introduced into the interior chamber 732 of the attachment portion 730. The operator then actuates the actuator 304 from the open position to the closed position, which moves the pair of locking elements 306 from the unlocked position to the locked position. In FIG. 7A, the accessory 400 is hence selectively fastened to the clamping component 700 in a first “stacked” configuration between (i) the rim portion 301 of the toolless fastener 300 on one side thereof, and (ii) the attachment portions 710 and 730 on the other side thereof.

During assembly in a second stacked configuration seen in FIG. 7B, the given member is inserted between the attachment portions 710 and 730 and the resilient clip portion is snap-fitted onto the given member. The pair of locking elements 306 and the receivable portion 303 are received in the channel 712 of the attachment portion 710. The pair of locking elements 306 and the receivable portion 303 are then received in the aperture 410 of the accessory 400. The pair of locking elements 306 and the receivable portion 303 are received in the aperture 734 and are introduced into the interior chamber 732 of the attachment portion 730. The operator then actuates the actuator 304 from the open position to the closed position, which moves the pair of locking elements 306 from the unlocked position to the locked position. In FIG. 7B, the accessory 400 is hence selectively fastened to the clamping component 700 in the second configuration between (i) rim portion 301 of the toolless fastener 300 and the attachment portion 710 on one side thereof, and (ii) the attachment portion 730 on the other side thereof.

In some embodiments of the present technology, it can be said that a given clamping component may have a resilient clip portion having two ends and that the clamping component further comprises attachment portions located on the two ends of the resilient clip portion, respectively. In some embodiments, it is contemplated that instead of having a resilient clip portion, the given clamping component may have two resilient clip portions pivotably connected to one another via a hinge.

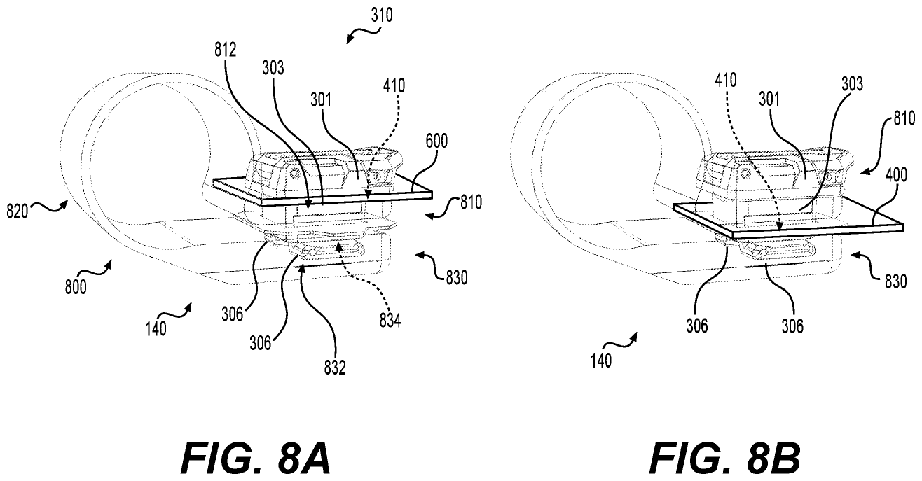

With reference to FIGS. 8A and 8B, there is depicted a clamp assembly 140 in accordance with an other embodiment of the present technology. The clamp assembly 140 comprises the toolless fastener 300 (the resilient rim portion 308 has been omitted) and a clamping component 800.

The clamping component 800 comprises a resilient clip portion 820 and an attachment portion 810 extending from the resilient clip portion 820 on the one side thereof, an attachment portion 830 extending from the resilient clip portion 820 on the other side thereof. The attachment portion 810 defines a channel 812 for receiving at least a portion of the toolless fastener 300. The attachment portion 830 defines an interior chamber 832 and an aperture 834 for receiving at least a portion of the toolless fastener 300.

In some embodiments, at least one of the first and second attachment portions 810,830 and/or the accessory 400 may be adapted for receiving the other one of the at least one of the first and second attachment portions 810,830 and/or the accessory 400 during assembly. For example, the first attachment portion 810 and the accessory 400 may be configured to engage each other in a “male-female” configuration so as to guide and/or maintain a position of the first attachment portion 810 relative to the accessory 400 during assembly. In another example, first attachment portion 810 and the accessory 400 may be configured to engage each other in a “snap-fit” configuration so as to guide and/or maintain a position of first attachment portion 810 relative to the accessory 400 during assembly.

In some embodiments, at least one of the first and second attachment portions 810,830 may be adapted for receiving the other one of the at least one of the first and second attachment portions 810,830 during assembly. For example, the first attachment portion 810 and the second attachment portion 830 may be configured to engage each other in a “male-female” configuration so as to guide and/or maintain a position of the first attachment portion 810 relative to the second attachment portion 830 during assembly. In another example, the first attachment portion 810 and the second attachment portion 830 may be configured to engage each other in a “snap-fit” configuration so as to guide and/or maintain a position of the first attachment portion 810 relative to the second attachment portion 830 during assembly.

The clamping component 800 is similar to the clamping component 700, but the resilient clip portion 820 is shaped different from the resilient clip portion 720. During assembly, the operator can manipulate the clamping component 800, similarly to how the operator manipulated that clamping component 700, for assembling the clamp assembly 140 in a first configuration as seen in FIG. 8A and in a second configured as seen in FIG. 8B. In FIG. 8A, the accessory 400 is hence selectively fastened to the clamping component 800 in a first stacked configuration between (i) the rim portion 301 of the toolless fastener 300 on one side thereof, and (ii) the attachment portions 810 and 830 on the other side thereof. In FIG. 7B, the accessory 400 is hence selectively fastened to the clamping component 700 in the second stacked configuration between (i) the rim portion 301 of the toolless fastener 300 and the attachment portion 810 on one side thereof, and (ii) the attachment portion 830 on the other side thereof.

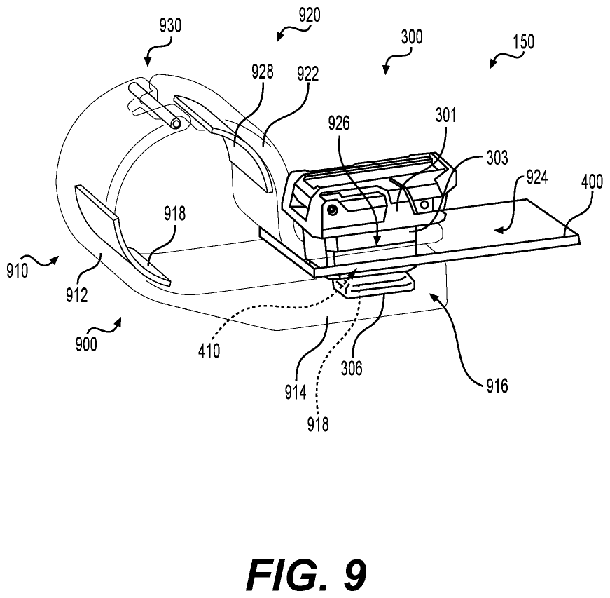

With reference to FIG. 9, there is depicted a clamp assembly 150 in accordance with an other embodiment of the present technology. The clamp assembly 150 comprises the toolless fastener 300 (the resilient rim portion 308 has been omitted) and a clamping component 900.

The clamping component 900 comprises a first jaw structure 910, and a second jaw structure 920 pivotably connected to the first jaw structure 910 via a hinge 930. The first jaw structure 910 comprises a resilient P-shaped jaw 912 and an attachment portion 914. The resilient P-shaped jaw 912 includes a padding 918 on inner surface thereof and is shaped to receive a given member of the vehicle. The attachment portion 914 defines an interior chamber 916 and an aperture 918 for receiving at least a portion of the toolless fastener 300. The second jaw structure 920 comprises an resilient curved jaw 922 and an attachment portion 924. An inner surface of the L-shaped jaw is shaped to receive the given member of the vehicle. The attachment portion 924 defines a channel 926 for receiving at least a portion of the toolless fastener 300. It should be noted that the resilient P-shaped jaw 912 and the resilient curved jaw 922 are made of a resilient material, as opposed to the P-shaped jaw 512 and the curved jaw 522 of the clamping component 500 in FIGS. 5A and 5B which are from a metal material. In some embodiments of the present technology, it is contemplated that the P-shaped jaw 512 and the curved jaw 522 from the clamp assembly 110 seen on FIGS. 5A and 5B may be made from a plastic material. As a result, the P-shaped jaw 512 and the curved jaw 522 may be embodied as resilient components of the clamp assembly 110.

In some embodiments, at least one of the first and second jaw structures 910,920 and/or the accessory 400 may be adapted for receiving the other one of the at least one of the first and second jaw structures 910,920 and/or the accessory 400 during assembly. For example, the first jaw structure 910 and the accessory 400 may be configured to engage each other in a “male-female” configuration so as to guide and/or maintain a position of the first jaw structure 910 relative to the accessory 400 during assembly. In another example, the first jaw structure 910 and the accessory 400 may be configured to engage each other in a “snap-fit” configuration so as to guide and/or maintain a position of the first jaw structure 910 relative to the accessory 400 during assembly.

In some embodiments, at least one of the first and second jaw structures 910,920 may be adapted for receiving the other one of the at least one of the first and second jaw structures 910,920 during assembly. For example, the first jaw structure 910 and the second jaw structure 920 may be configured to engage each other in a “male-female” configuration so as to guide and/or maintain a position of the first jaw structure 910 relative to the second jaw structure 920 during assembly. In another example, the first jaw structure 910 and the second jaw structure 920 may be configured to engage each other in a “snap-fit” configuration so as to guide and/or maintain a position of the first jaw structure 910 relative to the second jaw structure 920 during assembly.

It should be noted that in some embodiments a given clamp component may be made from a resilient material, while in other embodiments, a given clamping component may be made from non-resilient materials.

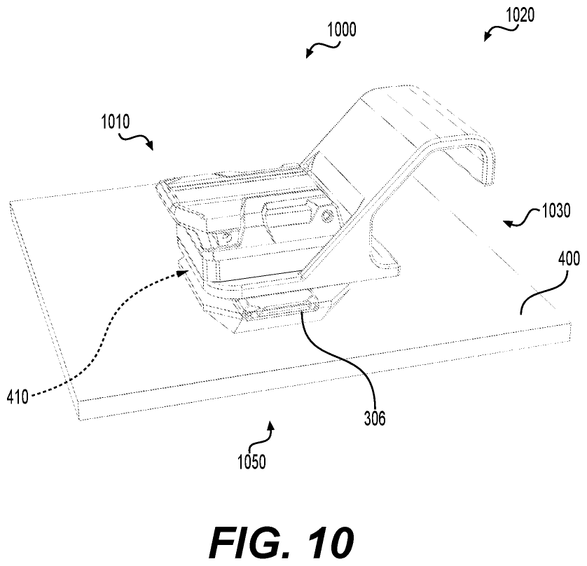

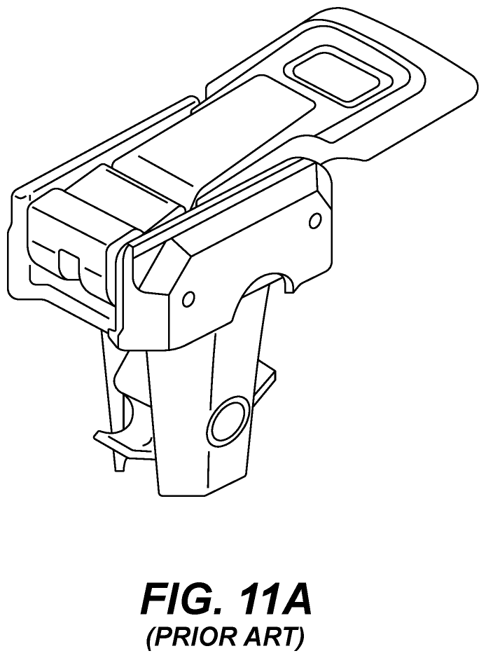

With reference to FIG. 10, there is depicted a clamp assembly 1000 in accordance with an other embodiment of the present technology. The clamp assembly 1000 comprises the toolless fastener 1010 and a clamping component 1020 and where the toolless fastener 1010 is an integral component of the clamping component 1020.

During installation, a pair of locking elements and a receiving portion of the integrated toolless fastener 1010 are received in the aperture 410 of the accessory 400, and the actuator of the integrated toolless fastener 1010 is actuated to move the pair of locking elements from the unlocked position to the locked position. The clamping component 1020 has a resilient clip portion 1030 that receives a member of the vehicle. The operator can install a snap-fit cap 1050 onto the pair of locking elements to shield the pair of locking elements during operator of the vehicle.

It is appreciated that these aspects of the present technology collaborate to provide an optimal selective attachment condition, without material variation between the different configurations of the clamp assembly. The various components of the clamp assembly are made of conventional materials (e.g., metallic materials, such as steel or aluminum, non-metallic material, such as plastics, and/or composite materials) via conventional manufacturing processes (e.g., casting, molding, 3d printing, etc.). The present technology does not require any specific materials nor methods of manufacture. The present technology merely requires that each component be suitable for the purpose for which it is intended and the use to which it is to be put. Any material(s) or method(s) of manufacture which produce such components may be used in the present technology.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

1. A clamping assembly, comprising:
a clamping component configured for selective attachment to a member of a vehicle;
a separate toolless fastener configured to selectively fasten an accessory to the clamping component,
the clamping component and the accessory being configured to cooperate with the separate toolless fastener such that:
when the separate toolless fastener engages the clamping component and the accessory, and is actuated to a locked position from an unlocked position, the separate toolless fastener selectively fastens the accessory to the clamping component.

2. The clamp assembly of claim 1, wherein the separate toolless fastener includes:
a housing;
an actuator pivotably connected to the housing and configured to move between an open position and a close position;
a locking element pivotably connected to the housing and configured to move between the unlocked position and the locked position;
the actuator and the locking element being configured to cooperate such that:
when the actuator is moved from the open position to the close position, the locking element moves from the unlocked position to the locked position.

3. The clamp assembly of claim 1, wherein the separate toolless fastener is a separate quick-action fastener.

4. The clamps assembly of claim 1, wherein the separate toolless fastener is a separate single-handed operable fastener.

5. The clamp assembly of claim 1, wherein the clamping component includes:
a clamping portion configured to selectively clamp onto the member;
and
an attachment portion extending from the clamping portion and configured to cooperate with the separate toolless fastener.

6. The clamp assembly of claim 5, wherein the clamping portion is a resilient clamping portion configured for a snap-fit connection with the member.

7. The clamp assembly of claim 5, wherein the attachment portion defines a lip for spacing the member from the accessory when the member is selectively fastened to the accessory.

8. The clamp assembly of claim 5, wherein the attachment portion defines an aperture configured to receive the separate toolless fastener.

9. The clamp assembly of claim 5, wherein the attachment portion is a first attachment portion, the clamping portion further including a second attachment portion extending from the clamping portion and configured to cooperate with the separate toolless fastener.

10. The clamp assembly of claim 9, wherein the clamping portion has:
a first jaw, the first attachment portion extending from the first jaw, and
a second jaw pivotably connected to the first jaw, the second attachment portion extending from the second jaw,
the first jaw and the second jaw configured to cooperate for selective attachment to the member.

11. The clamp assembly of claim 10, wherein the first jaw is one of a P-shaped jaw and a L-shaped jaw.

12. The clamp assembly of claim 9, wherein the second attachment portion defines a second aperture configured to receive the separate toolless fastener.

13. The clamp assembly of claim 2, wherein the clamp assembly further comprises a cap configured for snap-fit connection to the locking element when the member is selectively fastened to the accessory.

14. The clamp assembly of claim 2, wherein clamping component defines a first aperture and the accessory defines a second aperture, such that:
when the locking element is received by the first aperture and the second aperture, and is in the locked position,
the accessory is selectively fastened to the clamping component in a stacked configuration between the housing and the locking element.

15. The clamp assembly of claim 2, wherein when the member is selectively fastened to the accessory, the actuator and the housing are located in an interior space of the vehicle, and the locking element is located in one of: the interior space of the vehicle, and outside the interior space of the vehicle.

16. A kit for a clamp assembly, comprising:
a clamping component configured for selective attachment to a member of a vehicle;
a separate toolless fastener configured to selectively fasten an accessory to the clamping component,
the clamping component and the accessory being configured to cooperate with the separate toolless fastener such that:
when the separate toolless fastener engages the clamping component and the accessory, and is actuated to a locked position from an unlocked position, the separate toolless fastener selectively fastens the accessory to the clamping component.

17. The kit of claim 16, wherein the kit further comprises a second clamping component for selective attachment to the member of the vehicle.

18. The kit of claim 16, wherein the kit further comprises the accessory.

19. The kit of claim 16, wherein the clamping component is an integral component of the accessory.

20. The kit of claim 16, wherein the kit further comprises a cap configured for a snap-fit connection with the separate toolless fastener when the separate toolless fastener selectively fastens the accessory to the clamping component.
